(19) United States
(12) Patent Application Publication
(10) Pub. No.: US 2026/0317474 A1
(43) Pub. Date: Oct. 15, 2026

(54) CURABLE COMPOSITIONS BASED ON HIGH ACID VALUE RESINS USING ACID CURE MECHANISMS

(71) Applicant: PPG Industries Ohio, Inc., Cleveland, OH (US)

(72) Inventors: Hilary Ann Kerchner, Allison Park, PA (US); Hongying Zhou, Allison Park, PA (US); Scott Joseph Moravek, Mars, PA (US); Paul Hubert Lamers, Allison Park, PA (US); Francis Patrick Cassidy, Pittsburgh, PA (US); Visham Appadoo, Cranberry Township, PA (US); Rachel Elizabeth Ramsey, Pittsburgh, PA (US)

(73) Assignee: PPG Industries Ohio, Inc., Cleveland, OH (US)

(21) Appl. No.: 19/481,926

(22) PCT Filed: May 10, 2024
(86) PCT No.: PCT/US2024/028983

§ 371 Date: Nov. 6, 2025

Related U.S. Application Data
(60) Provisional application No. 63/501,999, filed on May 12, 2023.

(51) Int. Cl. C08G 18/79; B05D 3/02; C08G 18/08; C08G 18/38; C08G 18/42; C08G 18/62; C08G 63/66; C08G 63/88; C08K 5/17

(52) U.S. Cl. CPC C08G 18/797; B05D 3/0272; C08G 18/0823; C08G 18/0866; C08G 18/3876; C08G 18/4252; C08G 18/6229; C08G 63/66; C08G 63/88; C08K 5/17; B05D 2401/20; C08G 2150/00

(57) ABSTRACT

Provided are curable compositions that include high acid value resins and carbodiimides that form highly crosslinked networks. The curable compositions may be water-borne or aqueous and include a resin having acid functional groups with an acid value of at least 50 on resin solids according to ASTM D 4662-15, as well as a tertiary alkylated amine. The curable composition may also include less than 5 wt. % of any amine containing one or more hydroxyl group, based on solids of the composition. The curable composition may include a multifunctional carbodiimide as curing agent or crosslinker.

### CROSS-REFERENCE TO RELATED APPLICATION

This application claims the benefit of priority of U.S. Provisional Application 63/501,999 filed May 12, 2023, under 35 U.S.C. 119, titled “Curable Compositions Based on High Acid Value Resins Using Acid Cure Mechanisms”, which is incorporated herein by reference.

### FIELD

The present disclosure relates to a curable composition that includes a high acid value resin and a multifunctional carbodiimide, the curable composition curable via acid cure mechanisms.

### BACKGROUND

Curable compositions are used as coatings, adhesives, and sealants for a wide variety of industrial applications such as automotive, protective and marine, commercial transportation, consumer electronics, a variety of industrial and many others for decorative and functional applications. They are curable such that they are of low enough viscosity (less than 100,000 cps) for application but increase in molecular weight via crosslinking during and/or after application. This dramatically improves the properties of the curable composition as compared to its precursors.

Known curable compositions may include volatile organic compounds. “Volatile organic compound” or “VOC” typically means any organic compound that volatilizes before, during or after polymerization of the monomer mixture. VOCs are often regulated to certain limits based on the specific application of the coating being used. The regulatory landscape of VOCs has continued to change and limit VOCs in curable compositions.

### SUMMARY

The present disclosure provides curable compositions including high acid value resins (at least 50 mg KOH/g, such as at least 80 mg KOH on resin solids according to according to ASTM D 4662-15) and carbodiimides that form highly crosslinked networks. The curable compositions may be water-borne or aqueous and include a resin having acid functional groups as well as a tertiary alkylated amine. The curable composition may optionally include less than 5 wt. % of any amine containing a one or more hydroxyl group, based on the solids of the composition. The curable composition may include a multifunctional carbodiimide as curing agent or crosslinker.

The present disclosure further provides an article coated with a curable composition including high acid value resins and carbodiimides that form highly crosslinked networks. The curable compositions may be water-borne or aqueous and include a resin having acid functional groups with an acid value of at least 50 mg KOH/g, such as at least 80 mg KOH on resin solids according to ASTM D 4662-15, as well as a tertiary alkylated amine. The curable composition may optionally include less than 5 wt. % of any amine containing one or more hydroxyl groups, based on the solids of the composition. The curable composition may include a multifunctional carbodiimide as curing agent or crosslinker.

### DETAILED DESCRIPTION

The present disclosure provides a curable composition formed by an acid cure pathway that has increased solvent resistance and high crosslinking density compared to curable compositions with a low acid value, i.e., less than 50 mg KOH/g. The curable composition may be a coating composition, an adhesive composition, or a sealant composition.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. A range of “1 to 10” may be intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

As used herein, the term “acid cure pathway” refers to curing a composition that includes an acid functional resin and a crosslinking agent that includes functional groups capable of reacting with the acid groups in the acid functional resin.

As used herein, the term “active hydrogen” refers to a hydrogen atom that is bonded to an electronegative atom such as nitrogen, oxygen, or sulfur. Such hydrogen atoms are more acidic, i.e., the hydrogen more readily dissociates to generate a positive ion, compared to hydrogen atoms not bound to an electronegative atom, and are capable of participating in various chemical reactions.

Unless otherwise indicated, ambient conditions of temperature and pressure are ambient temperature (20-25° C., such as 23° C.) and standard pressure of 101.3 kPa (1 atm) at a relative humidity in the air of 35% to 75%, such as 55%.

As used herein, the term “aqueous” refers to a curable composition in the form of a solution, dispersion, latex or other mixture that includes at least 20 wt. % water based on the solids of the curable composition. If a curable composition also includes organic solvents, and aqueous compositions will include more than 50 wt. % water based on the total weight of all solvents (water and organic solvents.

As used herein, and unless otherwise stated, the terms “isocyanate equivalent weight” and “NCO equivalent weight” are recorded in grams per equivalent (g/eq) determined using ASTM D2572-19 (Standard Methods of Isocyanate Groups in Urethane Materials or Prepolymers) revised as follows. A dibutylamine solution of 78 g dibutylamine (available from Sigma Aldrich) in 4 liters of N-methyl-2-pyrrolidone (available from Fisher Scientific) was prepared in advance of sample testing. A sample having a weight between 1 and 2 grams was weighed accurately into a flask. The sample was reacted with 33 ml of the dibutylamine to form a substituted urea. The excess dibutylamine was then back-titrated with a solution of 0.2N hydrochloric acid in isopropyl alcohol (solution available from Fisher Scientific—Ricca). The amount of hydrochloric acid used to back-titrate the excess dibutylamine was used to calculate isocyanate (NCO) equivalent weight of the original sample.

As used herein, the terms “Multi-functional” and “Difunctional”, refers to a molecule having more than two, or two functional groups, respectively, as a nonlimiting example, when used in connection with carbodiimides, meaning that more than one carbodiimide functionality is present per molecule.

As used herein the term “organic” refers to chemical compounds in which one or more atoms of carbon are covalently linked and may include hetero atoms, which can include, without limitation, hydrogen, oxygen, or nitrogen. The term “organic solvent” refers to a solvent that includes organic compounds,

As used herein, the terms “Polymer” and “Polymeric” refer to oligomers, polymers, homopolymers (e.g., prepared form a single monomer species), copolymers (e.g., prepared form at least two monomer species), terpolymers (e.g., prepared from at least three monomer species), and graft polymers.

As used herein, the term “Acid value on solids,” refers to a quantified acidity of a given chemical substance based on the milligrams (mg) of potassium hydroxide (KOH) required to neutralize the acidic constituents in 1 gram of the non-volatile components.

As used herein, the term “Solids” refers to the non-volatile components present in a composition of volatile (does not evaporate at ambient conditions) and non-volatile components. As used herein, a weight percentage based on “solids” refers to an amount of a component based on a total weight of the non-volatile components of a composition.

As used herein, the term “Resin solids” refers to the non-volatile, organic components that make up the binder or film-forming components of the composition, excluding inorganic components such as pigments and fillers. As used herein, a weight percentage based on “resin solids” refers to an amount of a component based on a total weight of the binder or film-forming components of a composition.

As used herein, the term “solvent” refers to a substance capable of dissolving or dispersing other substances at ambient conditions.

Unless otherwise indicated, as used herein, the term “molecular weight” refers to a weight average molecular weight (“Mw”) as determined by gel permeation chromatography (GPC) using appropriate polystyrene standards. If a number average molecular weight (“Mn”) is specified, the weight is determined in the same GPC manner, while calculating a number average from the thus obtained polymer molecular weight distribution data. As a nonlimiting example, Mn refers to the total weight of a material divided by the number of molecules in the material and can be determined using gel permeation chromatography. Unless otherwise noted, Mw and Mn are in units of g/mol.

### II. Resin

Resins useful for the curable composition may include polyesters, polyurethanes, and acrylic polymers. These resins may include unreacted carboxylic acid groups to impart acid functionality that in addition to providing dispersibility to the curable composition are also capable of participating in curing and/or crosslinking reactions.

### A. Polyurethanes

Polyurethanes and methods of preparing them are well known in the art. As a nonlimiting example, the polyurethane can be prepared by reacting a polyester polyol, polycarbonate polyol, polyether polyol or acrylic polyol with a polyisocyanate and optionally an acid functional polyol (such as dimethylol propionic acid) such that the NCO/OH stoichiometric ratio is greater than 1:1 to generate an NCO functional prepolymer. The terminal isocyanates are then reacted with a non-tertiary aminoalcohol such as diethanolamine or ethanolamine to produce a terminal OH functional polymer. Some or all of the terminal OH groups may then be reacted with anhydrides such as succinic anhydride or methylhexahydrophthalic anhydride to produce a urethane polymer with terminal COOH groups. The acid groups introduced in the first stage of urethane preparation are considered to be internal COOH groups, while the acid groups introduced after reaction of the anhydride with aminoalcohol are considered to be terminal COOH groups. The acid functional polyurethane polymers may be neutralized with a tertiary alkylated amine prior to and/or after contact with water to provide water dispersibility.

As an alternative nonlimiting example, the terminal isocyanate group can be reacted with an acid monomer. The acid groups introduced in the first stage of urethane preparation are considered to be internal COOH groups, while the acid groups introduced after reaction of the anhydride with an aminoalcohol are considered to be terminal COOH groups. The acid functional polyurethane polymers may be neutralized with a tertiary alkylated amine prior to and/or after contact with water to provide water dispersibility (a uniform distribution of acid functional polyurethane in water).

The polyurethane may also be formed, without limitation, from an excess of isocyanate, an isocyanate reactive compound such as, without limitation, an acid containing polyol, and optionally a non-acid containing polyol. The prepolymer may then be reacted with a non-acid containing isocyanate reactive compound which may include hydroxyl groups, thiol groups, and/or non-tertiary amine groups and may be followed by reacting with a neutralizing amine to disperse the polyurethane into water.

Suitable polyisocyanates may be aliphatic, aromatic, cycloaliphatic or heterocyclic isocyanates. Representative examples are the aliphatic isocyanates such as trimethylene, tetramethylene, pentamethylene, hexamethylene, 1,2-propylene, 1,2-butylene, 2,3-butylene and 1,3-butylene diisocyanates; the cycloalkylene compounds such as 1,3-cyclopentane, 1,4-cyclohexane, 1,2-cyclohexane diisocyanates and isophorone diisocyanates; the aromatic compounds such as m-phenylene, p-phenylene, 4,4′-diphenyl, 1,5-naphthalene and 1,4-naphthalene diisocyanates; the aliphatic-aromatic compounds such as 4,4′-diphenylene methane diisocyanates, 2,4- or 2,6-tolylene diisocyanates, or mixtures thereof, 4,4′-toluidine, tetramethyl xylylene, and xylylene diisocyanates; the nuclear-substituted aromatic compounds such as dianisidine diisocyanate, 4,4′-diphenylether diisocyanate and chlorodiphenylene diisocyanate; the triisocyanates such as triphenyl methane-4,4′,4″-triisocyanate, 1,3,5-triisocyanato benzene and 2,4,6-triisocyanato toluene; and the tetraisocyanates such as 4,4′-dimethyldiphenyl methane-2,2′,5,5′-tetraisocyanate; the polymerized polyisocyanates such as tolylene diisocyanate dimers and trimers, and the like.

Suitable diisocyanates include aliphatic diisocyanates, aromatic diisocyanates, and mixtures thereof. Suitable diisocyanates are methylene-bis(4-cyclohexylisocyanate), isophorone diisocyanate, 1,4-cyclohexyl diisocyanate, 1,3-bis(isocyanatomethyl)cyclohexane, meta-tetramethylxylene diisocyanate (“TMXDI”), toluene diisocyanate, methylene diphenyl diisocyanate and/or a mixture thereof.

Suitable polyols may include alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; glycerol and the like or combinations thereof.

Suitable acid containing polyols may include dimethylol propionic acid, 2,2-bis(hydroxymethyl)butyric acid, tartaric acid, 3,5-dihydroxybenzoic acid, ascorbic acid and its isomers, and any acid derivatives of the polyols listed in the previous paragraph.

### B. Polyesters

Polyesters are well known in the art and may include the reaction product of a polyacid and a polyol. Suitable polyesters may be acid functional polyester generated by a polycondensation reaction, which are then dispersible into water.

“Polyacid” refers to a compound having two or more carboxylic acid groups, such as two, three or four acid groups, and includes an ester of the polyacid (wherein one or more of the acid groups is esterified) or an anhydride. The polyacid may be an organic polyacid.

The carboxylic acid groups of the polyacid may be connected by a bridging group selected from: an alkylene group; an alkenylene group; an alkynylene group; an arylalkylene group, an alkylarylene group, or an arylene group.

The polyester may be formed from any suitable polyacid. Suitable examples of polyacids include, but are not limited to the following: maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic acid; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; esters and anhydrides of all the aforementioned acids and combinations thereof.

“Polyol” refers to a compound having two or more hydroxyl groups, such as two, three or four hydroxyl groups. The hydroxyl groups of the polyol may be connected by a bridging group selected from: an alkylene group; an alkenylene group; an alkynylene group; an arylalkylene group, an alkylarylene group, or an arylene group. Suitably the polyol is an organic polyol.

The polyester may be formed from any suitable polyol. Suitable examples of polyols include, but are not limited to the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; glycerol and the like or combinations thereof.

The polyester may include polymers or copolymers formed from the reaction of diols and diacids, where polyols or polyacid components may optionally be used to produce branched polymers.

The polyester may be formed from a diacid. Suitable examples of diacids include, but are not limited to the following: phthalic acid; isophthalic acid; terephthalic acid; 1,4 cyclohexane dicarboxylic acid; succinic acid; adipic acid; azelaic acid; sebacic acid; fumaric acid; 2,6-naphthalene dicarboxylic acid; orthophthalic acid; phthalic anhydride; tetrahydrophthalic anhydride; maleic anhydride; succinic anhydride; itaconic anhydride; di-ester materials, such as dimethyl ester derivatives for example dimethyl isophthalate, dimethyl terephthalate, dimethyl 1,4-cyclohexane dicarboxylate, dimethyl 2,6-naphthalene di carboxylate, dimethyl fumarate, dimethyl orthophthalate, dimethylsuccinate, dimethyl glutarate, dimethyl adipate; esters and anhydrides of all the aforementioned acids; and mixtures thereof.

The polyester be formed from a diol. Suitable examples of diols include, but are not limited to the following: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; diethylene glycol; triethylene glycol; dipropylene glycol; tripropylene glycol; 2,2,4-trimethyl pentane 1,3-diol; 1,4 cyclohexane dimethanol; tricyclodecane dimethanol; 2,2,4,4-tetramethyl cyclobutane 1,3-diol; isosorbide; 1,4-cyclohexane diol; 1,1′-isopropylidene-bis (4-cyclohexanol); and mixtures thereof.

Alternatively, suitable polyesters may be acid polyesters generated by anhydride ring opening reactions. Such polyesters are also dispersible into water.

Suitable polyacids include polyacid half-esters obtained by reaction between a polyol and a 1,2-acid anhydride under conditions sufficient to ring open the anhydride forming the half-ester with substantially no polyesterification occurring. Such reaction products are of relatively low molecular weight (less than 10,000 g/mol), with a narrow weight distribution (Mw/Mn of less than 4), and provide lower volatile organic contents (less than 780 g/l of volatile organic compounds) in the curable composition while still providing for excellent properties in the resultant coating. By substantially no polyesterification occurring means that the carboxyl groups of the anhydride are not esterified by the polyol in a recurring manner. By this is meant that less than 10 by weight polyester is formed based on the total weight of the polyester resin.

To form the polyester, a 1,2-acid anhydride and polyol are contacted together usually by mixing the two together in a reaction vessel. The reaction may be conducted in the presence of an inert atmosphere such as nitrogen and in the presence of a solvent to dissolve the solid ingredients and/or to lower the viscosity of the reaction mixture.

Suitable solvents include, without limitation, ketones such as methyl amyl ketone, diisobutyl ketone, methyl isobutyl ketone; aromatic hydrocarbons such as toluene and xylene; as well as other organic solvents such as dimethyl formamide and N-methylpyrrolidone.

For a ring opening reaction and half-ester formation, a 1,2-acid anhydride may be used. Reaction of a polyol with an acid instead of an anhydride would require esterification by condensation eliminating water which would have to be removed by distillation. These conditions may promote undesired polyesterification. Also, the reaction temperature may be low, less than 135° C., such as less than 120° C., or less than 100° C., or less than 90° C. Temperatures greater than 135° C. may promote polyesterification, whereas temperatures less than 70° C. may cause a sluggish reaction.

The time of reaction can vary somewhat depending principally upon the temperature of reaction. Usually, the reaction time will be until a sufficiently constant acid value is obtained and may be from as low as 10 minutes to as high as 24 hours.

The equivalent ratio of anhydride to hydroxy of the polyol may be at least about 0.8:1 (the anhydride being considered monofunctional) so as to obtain maximum conversion to the desired half-ester.

Among the anhydrides which can be used in the formation of the polyesters are those which exclusive of the carbon atoms of the anhydride moiety contain from about 2 to 30 carbon atoms. Suitable anhydrides include aliphatic, including cycloaliphatic, olefinic and cycloolefinic anhydrides and aromatic anhydrides. Substituted aliphatic and aromatic anhydrides may also be included within the definition of aliphatic and aromatic provided the substituents do not adversely affect the reactivity of the anhydride or the properties of the resultant polyester.

Suitable substituents may be chloro, alkyl and alkoxy. Suitable anhydrides may include succinic anhydride, methylsuccinic anhydride, dodecenylsuccinic anhydride, octadecenylsuccinic anhydride, phthalic anhydride, tetrahydrophthalic anhydride, methyltetrahydrophthalic anhydride, hexahydrophthalic anhydride, alkylhexahydrophthalic anhydrides such as methylhexahydrophthalic anhydride, tetrachlorophthalic anhydride, endomethylene tetrahydrophthalic anhydride, chlorendic anhydride, itaconic anhydride, citraconic anhydride and maleic anhydride.

Among the polyols which can be used are simple polyols, that is, those containing from about 2 to 20 carbon atoms as well as polymeric polyols such as polyester polyols, polyurethane polyols and acrylic polyols.

Among the simple polyols that may be used are diols, triols and mixtures thereof. Suitable polyols may be those containing from 2 to 10 carbon atoms such as aliphatic polyols. Suitable polyols may include ethylene glycol, 1,2-propanediol, 1,3-propanediol, 1,4-butanediol, 1,5-pentanediol, glycerol, 1,2,3-butanetriol, 1,6-hexanediol, neopentyl glycol, diethylene glycol, dipropylene glycol, 1,4-cyclohexanedimethanol, trimethylolpropane, 2,2,4-trimethylpentane-1,3-diol, pentaerythritol, di(trimethylolpropane) and 1,2,3,4-butanetetrol. Aromatic polyols such as bisphenol A and bis(hydroxymethyl) xylene can also be used.

With regard to polymeric polyols, the polyester polyols are prepared by esterification of an organic polycarboxylic acid or anhydride thereof with organic polyols and/or an epoxide. The polycarboxylic acids and polyols may be aliphatic or aromatic dibasic acids or acid anhydrides and diols.

The diols that may be employed in forming the polyester include alkylene glycols such as ethylene glycol, neopentyl glycol and other glycols such as hydrogenated bisphenol A, cyclohexanediol, cyclohexanedimethanol, the reaction products of lactones and diols, the reaction product of epsilon-caprolactone and ethylene glycol, hydroxy-alkylated bisphenols, polyester glycols, poly(oxytetramethylene)glycol, and the like. Polymeric polyols of higher functionality can be used.

The acid component of the polyester may consist of monomeric carboxylic acids or anhydrides having 2 to 18 carbon atoms per molecule. Suitable acids may include phthalic acid, isophthalic acid, terephthalic acid, tetrahydrophthalic acid, hexahydrophthalic acid, methylhexahydrophthalic acid, adipic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

Besides the polyester polyols formed from polybasic acids and polyols, polylactone-type polyesters can also be employed. These products are formed from the reaction of a lactone such as epsilon-caprolactone and a polyol such as ethylene glycol, diethylene glycol and trimethylolpropane.

The polyester may be neutralized for dispersion in aqueous media by adding a base, such as a tertiary alkylated amine, for example triethyl amine (TEA), N-ethyl-N-(propan-2-yl)propan-2-amine (DIPEA), and 2,2′(methylazanedyl)di(ethan-1-ol).

### C. Acrylic Polymers/Resins

Acrylic polymers may include copolymers containing carboxylic acid groups and acid groups of sulfur and phosphorus. These acrylic polymers can be synthesized from acid monomers and one or more alkyl esters of (meth)acrylic acid. The acid monomers may include: (meth)acrylic acid, maleic acid, fumaric acid, crotonic acid, itaconic acid, 2-sulfo ethyl methacrylate, 2-acrylamido-2-methyl-1-propane sulfonic acid, (meth)acrylamido methyl phosphonic acid, and 2-phosphoethyl (meth)acrylate. The presence of these acid groups facilitates dispersing the acrylic polymer in water in the presence of an amine neutralizing compound. Monoalkyl esters of maleic acid, fumaric acid, and itaconic acid can also be used to synthesize the acrylic polymers. As will be appreciated by, and as is conventional to those skilled in the art, (meth)acrylic acid includes both acrylic acid and the coordinating methacrylic acid; the same is true for other compounds with the prefix “(meth)”.

Alkyl esters of (meth)acrylic acid may include aliphatic or cycloaliphatic alkyl esters containing from 1 to 30 carbon atoms in the alkyl groups, such as 4 to 18 carbon atoms in the alkyl group. Methyl (meth)acrylate, ethyl (meth)acrylate, butyl(meth)acrylate, 2-ethyl hexyl (meth)acrylate, and hydroxy ethyl (meth)acrylate are all suitable alkyl esters of (meth)acrylic acid.

The acrylic polymers may further include copolymers synthesized from one of the below-mentioned monomers and one or more of the following polymerizable ethylenically unsaturated monomers: vinyl aromatic compounds such as styrene and vinyl toluene; nitriles such as (meth)acrylonitrile; amides such as (meth)acrylamide; vinyl and vinylidene halides such as vinyl chloride; and vinylidene chloride and vinyl esters such as vinyl acetate.

### D. Solvent

The polyurethane, polyester, and acrylic polymer resins described above each may be formed without solvent or with the use of solvents.

Alternatively, the polyurethane, polyester, and acrylic polymer resins described above each may be formed in a solvent medium. The solvent medium may be added to the resin to adjust the concentration of the resin.

Suitable solvents may include, without limitation, organic solvents, such as ester, ketone, hydrocarbon or mixtures thereof. Suitable ester solvents include methyl esters such as succinate, adipate, and glutarate methyl esters and alkyl acetates such as ethyl acetate, n-butyl acetate, n-hexyl acetate, and mixtures thereof. Examples of suitable ketone solvents include methyl ethyl ketone, methyl isobutyl ketone, and mixtures thereof. Examples of suitable hydrocarbon solvents include toluene, xylene, aromatic hydrocarbons, and aliphatic hydrocarbons such as hexane, heptanes, and nonane.

The resin may include an amount of organic solvent from 0 wt. %, 5 wt. %, 10 wt. % to 20 wt. %, 30 wt. %, 40 wt. % or within any range using any two of the foregoing values as endpoints, such as 0 wt. % to 40 wt. %, 5 wt. % to 30 wt. %, or 10 wt. % to 20 wt. 00 where wt. % is based on a total weight of the resin.

### E. Resin Properties

The active hydrogen containing resin can have a weight average molecular weight greater than 1,000 g/mol and a number average molecular weight greater than 500 g/mol, with number average molecular weight from at least 500 g/mol, such as at least 1000 g/mol, or at least 2000 g/mol, or at least 3000 g/mol, or at least 4000 g/mol and can be up to 50,000 g/mol g/mol, such as up to 40,000 g/mol, or up to 30,000 g/mol or within any range using any two of the foregoing values as endpoints, such as from 500 g/mol to 50,000 g/mol, or from 1000 g/mol to 40,000 g/mol, or from 2000 g/mol to 30,000 g/mol. Weight average molecular weight and number average molecular weight both as determined by gel permeation chromatography using polystyrene standards.

The curable composition may include one or more resins. The resin may have only acid groups, as described above, may have both acid and hydroxyl groups, and/or may have only hydroxyl groups, and combinations of the foregoing resins may be used. In instances where a resin only including hydroxyl groups is used, a resin that includes acid groups would also be used in combination with the resin that only includes hydroxyl groups.

The active hydrogen containing resin used according to the present disclosure can have an acid value on solids greater than 50 mg KOH/g, such as greater than greater than 80 mg KOH/g, or greater than 85 mg KOH/g, or greater than 90 mg KOH/g, or up to 95 mg KOH/g, such as up to 100 mg KOH/g, on resin solids, or within any range using any two of the foregoing values as endpoints, such as from 50 mg KOH/g to 150 mg KOH/g, such as from 80 mg KOH/g to 100 mg KOH/g, or from 80 mg KOH/g to 95 mg KOH/g, or from 85 mg KOH/g to 100 mg KOH/g. Acid values may be determined using a Metrohm 798 MPT Titrino automatic titrator, manufactured by Metrohm AG (Herisau, Switzerland), according to ASTM D 4662-15, then divided by the solids content to results in acid value on solids. The high acid value can improve the solvent resistance of coating compositions using the high acid value polyurethane resins.

The curable composition of the present disclosure may include an amount of active hydrogen containing resin of from 20 wt. %, such as from 30 wt. %, or from 40 wt. %, or from 50 wt. %, or from 60 wt. % up to 70 wt. %, such as up to 80 wt. %, or up to 85 wt. %, or within any range using any two of the foregoing values as endpoints, such as from 20 wt. % to 85 wt. %, or from 30 wt. % to 80 wt. %, or from 40 wt. % to 70 wt. %, where wt. % is based on total resin solids.

### III. Tertiary Alkylated Amine

The curable composition can include at least one tertiary alkylated amine to neutralize the acid groups in the resin. Neutralizing amine can aid in controlling the reaction rate by effectively limiting reactivity of the acid group. The tertiary alkylated amine neutralized acid groups also can help to render the resin more water soluble. A tertiary amine may be any amine with a nitrogen atom directly bonded to three carbons of any hybridization which are not carbonyl group carbons.

The curable composition may include an amount of tertiary alkylated amine from less than 10 wt. %, such as from less than 8 wt. %, or from less than 5 wt. %, or from less than 3 wt. %, or from less than 1 wt. % or can range from 0.1 wt. % to 10 wt. %, such as from 0.25 wt. % to 8 wt. %, or from 0.5 wt. % to 5 wt. %, based on a total weight of the composition.

Suitable amines can include tertiary alkylated amines that do not include hydroxyl groups. Suitable tertiary amines may include, triethylamine, tributylamine, 1,4-diazabicyclo[2.2.2]octane, 1,8-diazabicylco[5.4.0]undec-7-ene, tripropylamine, and diisopropylethylamine.

The composition may include an amount of any tertiary alkylated amine that includes a one or more hydroxyl group from less than 5 wt. %, such as from less than 4 wt. %, or from less than 3 wt. % to less than 2 wt. %, or less than 1 wt. %, or can range from 0 wt. % to 5 wt. %, such as from 0.1 wt. % to 4 wt. %, or from 0.25 wt. % to 3 wt. %, based on solids of the composition (i.e., (weight of amine/solids)×100).

The curable composition may be substantially free, essentially free or completely free of amines that include a hydroxyl group. Further, the curable composition may be essentially free of amines that include a hydroxyl group. “Substantially free” may refer to a curable composition that includes less than 1 wt. % of amines that include a hydroxyl group. “Essentially free” may refer to a curable composition that includes less than 0.05 wt. % of amines that include a hydroxyl group per molecule, where wt. % is based on the solids of the composition. “Completely free” refers to a curable composition that does not include detectable levels of amines that include a hydroxyl group.

### IV. Multifunctional Carbodiimide

The curable composition may contain a water-dispersible polycarbodiimide that is multi- or at least di-functional and reactive with the carboxylic acid in the resin during dehydration and amine volatilization of curable composition to form a crosslinked composition. In order to utilize certain carbodiimides, it may be necessary to modify the carbodiimides to make them water dispersible. Techniques for modifying carbodiimides to make them water dispersible are well known in the art.

As used herein, the term “multifunctional carbodiimide” or “polycarbodiimide” refers to a molecule, such as a polymer molecule, containing two or more units having the structure: —N═C═N—. As will be appreciated, polycarbodiimides can generally be prepared by a condensation reaction of a polyisocyanate in the presence of a suitable catalyst to form a polycarbodiimide intermediate having terminal NCO-functionalities and by terminating and/or chain extending the polycarbodiimide intermediate by the addition of one or more compounds that includes reactive hydrogen atoms, such as an amine and/or a hydroxy-containing compound.

The polycarbodiimide polymers can be made by any of a variety of methods starting from a polycarbodiimide intermediate having terminal NCO-functionalities. Moreover, the polycarbodiimide polymers can be produced from a polycarbodiimide intermediate made with or without use of a reactive hydrogen-containing chain extender.

To prepare a polycarbodiimide, an isocyanate terminated polycarbodiimide intermediate may be first formed by a condensation reaction of a polyisocyanate, which may or may not have been previously chain extended by the reaction of a polyisyocanate with an active-hydrogen containing chain extender of the type previously described. The polyisocyanate may be condensed with the elimination of carbon dioxide to form the isocyanate terminated polycarbodiimide.

The resulting polycarbodiimide, which may or may not be chain extended, has terminal isocyanate groups. The isocyanate terminated polycarbodiimide can then be further reacted or capped by reacting the terminal isocyanate groups with a reactive hydrogen-containing hydrophilic compound to impart hydrophilicity to the polycarbodiimide enabling it to be dispersed in water, or other compound to impart hydrophobic capacity to the polycarbodiimide.

Muti-functional carbodiimides are commercially available. Suitable carbodiimides may include UCARLINK XL-29SE, XL-20 commercially available from Union Carbide, CARBODILITE V-02-L2 commercially available from Nisshinbo Industries, Inc. and Picassian® XL-732 from Stahl may be used in the present disclosure.

The carbodiimide of the present disclosure may be linear or branched.

The curable composition may include a stoichiometric ratio of carbodiimide to acid of at least 1:2, such as at least 1:1, or at least 1:1.25, or at least 1:1.1, or at least 1:1.01 and can be up to 2:1, such as up to 1.5:1, such as up to 1.25:1, such as up to 1.1:1 such as up to 1.01:1, and can range from 1:2 to 2:1, such as from 1:1.5 to 1.5:1, such as from 1:1.25 to 1.25:1, such as from 1:1.1 to 1.1:1, or from 1:1.01 to 1.01:1, such as from 1:1.1 to 1.25:1.

The curable composition may include an amount of multi-functional carbodiimide from at least 15 wt. %, such as at least 30 wt. %, or at least 40 wt. %, and up to 85 wt. %, such as up to 70 wt. %, such as up to 60 wt. %, or up to 50 wt. %, or within any range using any two of the foregoing values as endpoints, such as from 15 wt. % to 85 wt. %, or from 30 wt. % to 70 wt. %, or from 40 wt. % to 60 wt. %, where wt. % is based on total resin solids.

### V. Additives

The curable composition may further include one or more additives. Such additives can include solvents, water, colorants such as pigments and/or dyes, plasticizers, antioxidants, hindered amine light stabilizers, UV light absorbers and stabilizers, surfactants, surface agents, flow control agents, thixotropic agents, fillers, organic cosolvents, reactive diluents, leveling agents, defoamers, catalysts, grind vehicles, and other customary auxiliaries.

### VI. Application of the Composition and Curing Conditions

The curable composition may be applied to an article or substrate using spray coating, roller coating, coil coating, dip coating, precision coating, or spin coating techniques. The curable composition may be deposited over at least a part of a surface of the article and cured to form a cured layer.

There are a number of known curable compositions used in the art. Cure chemistries may include an acid functional polymer, such as polyurethanes, polyesters, acrylic polymers, and a crosslinking component. These coating may be used as film forming coatings for substrates.

The curable compositions may be curable at a temperatures from at least 0° C., such as at least 10° C., or at least 20° C., or at least 30° C. and up to 120° C., such as up to 110° C., or up to 90° C., or up to 75° C., or up to 60° C., or up to 40° C., or within any range using any two of the foregoing values as endpoints, such as from 0° C. to 120° C., such as from 10° C. to 110° C., or from 0° C. to 75° C., or from 20° C. to 75° C.

### VII. Acid Cure Pathway

The curable composition may be formed through an acid cure pathway as described below. The curable composition formed through the acid cure pathway may include a resin having acid functional groups; a tertiary alkylated amine; and a multifunctional carbodiimide.

The resin having acid functional groups may react with the multifunctional carbodiimide, forming an O-acylisourea intermediate. The O-acylisourea intermediate then may rearrange forming a stable N-acylurea. This pathway may continue to form crosslinks between the carbodiimide and resin, forming a high XLD curable composition.

The curable composition may include a stoichiometric ratio of carbodiimide to acid of at least 1:2, such as at least 1:1.5, or at least 1:1.25, or at least 1:1.1, or at least 1:1.01 and can be up to 2:1, such as up to 1.5:1, such as up to 1.25:1, such as up to 1.1:1 such as up to 1.01:1, and can range from 1:2 to 2:1, such as from 1:1.5 to 1.5:1, such as from 1:1.25 to 1.25:1, such as from 1:1.1 to 1.1:1, or from 1:1.01 to 1.01:1, such as from 1:1.1 to 1.25:1.

### VIII. Properties of Cured Composition

Curable compositions formed using the acid cure pathway may exhibit resistance to solvents and increased cross-linking density (XLD) compared to curable compositions with a low acid value, i.e., less than 50 mg KOH/g. The curable composition of the present disclosure may be entirely free of VOC.

### A. Solvent Resistance Test

To test the resistance of a curable composition, a substrate coated with the curable composition may be subjected to a solvent resistance test according to the method described below.

A solvent resistance test may be performed by placing a test panel on a flat table or other suitable flat, firm surface. Two sterile gauze pads may be affixed over the end of a one-pound Ball-Peen hammer. The gauze may be affixed such that it is snugly held in place with a rubber band and has four layers of gauze over the end of the hammer with no wrinkles.

The gauze is saturated with an appropriate solvent, such as methyl ethyl ketone (MEK), for the substrate being tested. The gauze is re-saturated every 25 double rubs.

The substrate coated with the curable composition is immediately rubbed with the saturated gauze over the test area using a back-and-forth stroke of 2-4 inches. The weight of the hammer controls the downward pressure.

The back-and-forth strokes may be continued, counting one “double rub” for each forward and backward motion completed until the bare substrate is exposed in the center of the strip where the rubs are performed.

The number of “double rubs” are recorded as the test result. The gauze should be removed and replaced with new gauze in between each sample tested.

The curable composition formed using the methods described herein may have a solvent resistance of at least 60 MEK double rubs (MEKDR), at least 70 MEK double rubs, at least 80 MEK double rubs, at least 100 MEK double rubs, with a rating of 8 or greater according to the following scale:

| Rating | Description |
|---|---|
| 0 | Total and consistent breakthrough |
| 1 | Coating dissolving, smearing |
| 2 | Heavy abrasion with breakthrough |
| 3 | Adhesive damage, little abrasion, coating brittle like |
| 4 | Break through, sporadic-chatter |
| 5 | Light abrasion, thin break through |
| 6 | Wide abrasion, edges beginning to break through |
| 7 | Wide abrasion, no break through |
| 8 | Light abrasion, no break through |
| 9 | Very light impression on side edges |
| 10 | No visible damage |

### B. Solvent Swelling Test

In general, the higher the cross-link density (XLD) the lower the permeability to the diffusion of solvents and chemicals at a given film thickness. The curable composition formed by the acid cure pathway may be tested for the amount of solvent swelling to determine the cross-linking density of each curable composition. The less swelling the free film experiences when exposed to a solvent, the higher the crosslink density may be.

The Solvent Swelling Test requires a free film of the composition to be tested. Free film preparation: an area of Tedlar film (PVF film TTR10SG3 available from DuPont) is wrapped around a suitable substrate and then secured with tape. The Tedlar wrapped substrate is then baked at 166° C. for 30 minutes to shrink fit the Tedlar and create a low adhesion surface. The desired liquid coating is then applied to the Tedlar and cured.

Free Films were allowed to reach 7 days post cure before testing. Method involves cutting a small disk and measuring size via microscope. A small disc is cut and removed from the Tedlar substrate, thus obtaining a free film which is placed on a concave or standard microscope slide. Under a microscope, the initial area of disk is measured. A few drops of methylene chloride are added to the well in the slide and the area of the swollen disc is determined. Images can be acquired through the Nikon Eclipse ME600 optical microscope and AmScope software package. Images are analyzed using image analysis software such as Fiji-ImageJ. The crosslink density is then calculated using the Flory-Rehner Equation. Less swelling is associated with higher crosslink density.

### Calculations:

1. Calculate f, the fractional increase in linear size, with the following equation:

$$f = \frac{\sqrt{{A}_{w}} - \sqrt{{A}_{d}}}{\sqrt{{A}_{d}}}$$

where A_{w} is the area of the sample after swelling, and A_{d} is the area of the dry sample.
2. Calculate v₂, the volume fraction of polymer in a swollen film, with the following equation:

$${v}_{2} = \frac{1}{{( 1 + f )}^{3}}$$

3. Calculate vₑ, the crosslink density in moles/cc, with the following equation:

$$\text{?} = \frac{- [ ln ( 1 - {v}_{2} ) + {v}_{2} + {x}_{2} {v}_{2}^{2} ] / {V}_{1}}{{v}_{2}^{1 / 3} - {v}_{2} / 2}$$

$$\text{?} \text{indicates text missing or illegible when filed}$$

where x₁=0.4, the interaction parameter of methylene chloride with the network polymer and V₁=63.6 m³/mol at, the molar volume of methylene chloride.

The curable composition formed using the acid cure pathway may have a crosslink density of at least 0.6 mmol/cm³, at least 0.7 mmol/cm³, at least 0.8 mmol/cm³, or at least 1.0 mmol/cm³, as determined using the solvent swelling test described above.

### C. Molecular Weight

Gel permeation chromatography (GPC) may be used to determine molecular weight, such as number average molecular weight (Mn), and weight average molecular weight (Mw) using a polystyrene standard according to ASTM D6579-11 performed using a Waters 2695 separation module with a Water 2414 differential refractometer (RI detector).

Tetrahydrofuran (THF) may be used as the eluent at a flow rate of 1 mL/min and two PLgel Mixed-C (300×7 5 mm) columns may be used for separation at room temperature (about 20° C.).

Weight and number average molecular weight of polymetric samples can be measured by gel permeation chromatography relative to linear polystyrene standards of 800 to 900,000 Da.

### Aspects

Aspect 1. An aqueous curable composition that comprises:
a resin that comprises acid functional groups, the resin having an acid value from 50 mg KOH/g to 150 mg KOH/g on resin solids according to ASTM D 4662-15;
a tertiary alkylated amine; and
a multifunctional carbodiimide.

Aspect 2. The curable composition of aspect 1, where the an acid value of the resin is from 80 mg KOH/g to 150 mg KOH/g, such as from 85 mg KOH/g to 140 mg KOH/g, or from 90 mg KOH/g to 130 mg KOH/g, or from 80 mg KOH/g to 125 mg KOH/g on resin solids according to ASTM D 4662-15;

Aspect 3. The curable composition of aspects 1 or 2, where the composition comprises less than 5 wt. % of an amine that comprises one or more hydroxyl groups, based on solids of the composition.

Aspect 4. The curable composition of any preceding aspect, where the composition comprises less than 10 wt. % of the amine, based on a total weight of the composition.

Aspect 5. The curable composition of any preceding aspect, where the curable composition is substantially free (less than 1 wt. %), essentially free (less than 0.05 wt. %) or completely free (undetectable) of amines that comprise a hydroxyl group, where wt. % is based on solids of the curable composition.

Aspect 6. The curable composition of any preceding aspect, where the resin that comprises acid functional groups comprises a polyester, a polyurethane and/or an acrylic resin.

Aspect 7. The curable composition of any preceding aspect, where the carbodiimide comprises a linear or branched multifunctional carbodiimide.

Aspect 8. The curable composition of any preceding aspect, further comprising a solvent.

Aspect 9. The curable composition of any preceding aspect, where the composition is curable at a temperature of from 0° C. to 120° C.

Aspect 10. The curable composition of any preceding aspect, where the composition is curable at a temperature of from 10° C. to 110° C., such as from 0° C. to 75° C., or from 0° C. to 70° C., or from 20° C. to 70° C.

Aspect 11. The curable composition of any preceding aspect, where a stoichiometric ratio of carbodiimide to acid is from 1:2 to 2:1, such as from 1:1.5 to 1.5:1, such as from 1:1.25 to 1.25:1, such as from 1.0:1.1 to 1.1:1, or from 1:1.01 to 1.01:1, such as from 1:1.1 to 1.25:1.

Aspect 12. The curable composition of any preceding aspect, where a stoichiometric ratio of carbodiimide to acid is from 1:1.5 to 1.5:1, such as from 1:1.25 to 1.25:1, such as from 1.0:1.1 to 1.1:1, or from 1:1.01 to 1.01:1, such as from 1:1.1 to 1.25:1.

Aspect 13. The curable composition according to any preceding aspect, where the resin that comprises acid functional groups has a number average molecular weight, of from 500 g/mol to 50,000 g/mol determined by gel permeation chromatography using polystyrene standards.

Aspect 14. The curable composition according to any preceding aspect, where the resin that comprises acid functional groups has a number average molecular weight, of from 1000 g/mol to 40,000 g/mol, such as from 2000 g/mol to 30,000 g/mol determined by gel permeation chromatography using polystyrene standards.

Aspect 15. An article that comprises the curable composition of any preceding aspect deposited over at least a part of a surface of the article and cured to form a cured layer.

Aspect 16. The article of aspect 15, where the cured layer has a crosslink density of at least 0.6 mmol/cm³ as determined by a solvent swelling test using the Flory-Rehner equation.

Aspect 17. The article of either of aspects 15 or 16 where the curable composition is cured at a temperature of from 0° C. to 120° C.

Aspect 18. The article of either of aspects 15 or 16, where the curable composition is cured at a temperature of from 20° C. to 110° C., such as from 0° C. to 75° C., or from 30° C. to 75° C.

Aspect 19. A method of applying the curable composition according to any of aspects 1 through 14, that comprises:
applying the curable composition over at least a portion of a surface of an article or substrate using spray coating, roller coating, coil coating, dip coating, precision coating, and/or spin coating techniques; and
curing the curable composition to form a cured layer.

Aspect 20. The method of aspect 19, where the curable composition is cured at a temperature of from 0° C. to 120° C.

Aspect 21. The method of aspect 19, where the curable composition is cured at a temperature of from 20° C. to 110° C., such as from 0° C. to 75° C., or from 30° C. to 75° C.

### EXAMPLES

Unless otherwise stated, NCO equivalent weight (in grams per equivalent; g/eq) was determined using ASTM D2572-19 (Standard Methods of Isocyanate Groups in Urethane Materials or Prepolymers) revised as described as follows: A dibutylamine solution of 78 g dibutylamine (available from Sigma Aldrich) in 4 liters of N-methyl-2-pyrrolidone (available from Fisher Scientific) was prepared in advance of sample testing. A sample having a weight between 1 and 2 grams was weighed accurately into a flask. The sample was reacted with 33 ml of the dibutylamine to form a substituted urea. The excess dibutylamine was then back-titrated with a solution of 0.2N hydrochloric acid in isopropyl alcohol (solution available from Fisher Scientific—Ricca). The amount of hydrochloric acid used to back-titrate the excess dibutylamine was used to calculate NCO equivalent weight of the original sample.

Aspects of the present disclosure are further illustrated by reference to the following examples. It will be apparent to those skilled in the art that many modifications, both to materials, and methods, may be practiced without departing from the scope of the disclosure.

### Example 1: Preparation of Acid Functional Resins

A predispersed resin PU-1 was prepared according to Table 1.

To a four necked reaction flask outfitted with a stirrer, gas inlet, thermometer and condenser was added the contents of Charge 1. After the exotherm subsided, the temperature was raised to 80° C. and held for 3 hours. The NCO equivalent weight was measured (1364 g/eq, theory 1290 g/eq). The reaction was cooled to 50° C. Charge 2 was added and reaction was allowed to exotherm. Once the exotherm subsided the reaction was held at 65° C. until the NCO level was undetectable as measured by transmission Fourier Transform Infrared (FTIR) Spectroscopy. Charge 3 was added. The reaction was heated to 80° C. and held until the cyclic anhydride was undetectable via FTIR. The predispersion had a measured solids content of 74.2% (using ASTM D2369-20), measured acid value which results in an acid value of 98 mg KOH/g on resin solids and a theoretical hydroxyl number of 49 mg KOH/g on resin solids (based on the equivalents of hydroxyl groups and anhydride groups used).

TABLE 1
Predispersion PU-1 Formulation

| Charge | Raw Material | Amount (g) |
|---|---|---|
| 1 | PolyTHF ® 650¹ | 195.0 |
| | Dimethylol Propionic Acid | 80.4 |
| | Isophorone Diisocyanate | 266.4 |
| | Dibutyltin Dilaurate | 0.27 |
| | Methyl Ethyl Ketone | 232.3 |
| 2 | Diethanol Amine | 59.6 |
| | Methyl Ethyl Ketone | 25.4 |
| 3 | Succinic Anhydride | 56.8 |
| | Methyl Ethyl Ketone | 24.1 |

¹Available from BASF

### Example 2: Preparation of Acid Functional Resin Predispersion

Predispersed resin PU-2 was prepared according to Table 2, below. To a four necked reaction flask outfitted with a stirrer, gas inlet, thermometer and condenser was added the contents of Charge 1. After the exotherm subsided, the temperature was raised to 80° C. and held for 3 hours. The NCO equivalent weight was measured (1360 g/eq, theory 1290 g/eq). The reaction was cooled to 50° C. Charge 2 was added and reaction was allowed to exotherm. Once the exotherm subsided the reaction was held at 65° C. until the NCO was undetectable as measured by FTIR. Charge 3 was added. The reaction was heated to 80° C. and held until the cyclic anhydride was undetectable via FTIR. The predispersion had a measured solids content of 73.8%, measured acid value which results in an acid value of 93 mg KOH/g on resin solids and a theoretical hydroxyl number of 49 mg KOH/g on resin solids. The molecular weight was determined to be Mn of 2857 and Mw of 5850 according to the GPC method described above.

TABLE 2
Predispersion PU-2 Formulation

| Charge | Raw Material | Amount (g) |
|---|---|---|
| 1 | PolyTHF ® 650¹ | 195.0 |
| | Dimethyol Propionic Acid | 80.4 |
| | Isophorone Diisocyanate | 266.4 |
| | Dibutyltin Dilaurate | 0.27 |
| | Methyl Ethyl Ketone | 232.3 |
| 2 | Diethanol Amine | 59.7 |
| | Methyl Ethyl Ketone | 25.5 |
| 3 | Methylhexahydrophthaliic | 95.7 |
| | Anhydride | |
| | Methyl Ethyl Ketone | 40.8 |

¹Available from BASF

### Example 3: Preparation of Acid Functional Resin Dispersion

A polyurethane dispersion PUD-1 was prepared according to the formulation of Table 3. To a four necked reaction flask outfitted with a stirrer, gas inlet, thermometer and condenser was added the contents of Charge 1 and heated to 65° C. To another four necked reaction flask outfitted with a stirrer, gas inlet, thermometer and condenser was added the contents of Charge 2 and 3 and heated to 30° C. The heated Charge 1 was added to Charges 2 and 3 in a reverse manner. The polyurethane dispersion had a measured solid content of 44.9% and a measured acid value of 94 mg KOH/g on resin solids.

TABLE 3
Polyurethane Dispersion PUD-1 Formulation

| Charge | Raw Material | Amount (g) |
|---|---|---|
| 1 | PU-1 | 200.0 |
| 2 | Triethyl Amine | 18.4 |
| 3 | Deionized Water | 160.4 |

### Example 4: Preparation of Acid Functional Resin Dispersion

A polyurethane dispersion PUD-2 was prepared according to the formulation of Table 4. To a four necked reaction flask outfitted with a stirrer, gas inlet, thermometer and condenser was added the contents of Charge 1 and heated to 65° C. To another four necked reaction flask outfitted with a stirrer, gas inlet, thermometer and condenser was added the contents of Charge 2 and 3 and heated to 30° C. The heated Charge 1 was added to Charge 2 and 3 in a reverse manner. The polyurethane dispersion had a measured solid content of 44.4% and a measured acid value of 92 mg KOH/g on resin solids.

TABLE 4
Polyurethane Dispersion PUD-2 Formulation

| Charge | Raw Material | Amount (g) |
|---|---|---|
| 1 | PU-1 | 200.0 |
| 2 | Diisopropylethyl amine | 23.5 |
| 3 | Deionized Water | 147.5 |

### Example 5: Preparation of Acid Functional Resin Dispersion

A polyurethane dispersion PUD-3 was prepared according to the formulation of Table 5. To a four necked reaction flask outfitted with a stirrer, gas inlet, thermometer and condenser was added the contents of Charge 1 and heated to 65° C. To another four necked reaction flask outfitted with a stirrer, gas inlet, thermometer and condenser was added the contents of Charge 2 and 3 and heated to 30° C. The heated Charge 1 was added to Charge 2 and 3 in a reverse manner. The polyurethane dispersion had a measured solid content of 44.5% and a measured acid value of 94 mg KOH/g on resin solids.

TABLE 5
Polyurethane Dispersion PUD-3

| Charge | Raw Material | Amount (g) |
|---|---|---|
| 1 | PU-1 | 200.0 |
| 2 | Dimethylethanol Amine | 16.2 |
| 3 | Deionized Water | 155.0 |

### Example 6: Preparation of Acid Functional Resin Dispersion

A polyurethane dispersion PUD-4 was prepared according to the formulation of Table 6. To a four necked reaction flask outfitted with a stirrer, gas inlet, thermometer and condenser was added the contents of Charge 1 and heated to 60° C. Charge 2 was added followed by Charge 3. The polyurethane dispersion had a measured solid content of 38.5% and a measured acid value of 90 mg KOH/g on resin solids.

TABLE 6
Polyurethane Dispersion PUD-4 Formulation

| Charge | Raw Material | Amount (g) |
|---|---|---|
| 1 | PU-2 | 200.0 |
| 2 | Triethyl Amine | 17.4 |
| 3 | Deionized Water | 205.8 |

### Example 7: Preparation of Acid Functional Resin Dispersion

A polyurethane dispersion PUD-5 was prepared according to the formulation of Table 7. To a four necked reaction flask outfitted with a stirrer, gas inlet, thermometer and condenser was added the contents of Charge 1 and heated to 60° C. Charge 2 was added followed by charge 3. The polyurethane dispersion had a measured solid content of 38.4% and a measured acid value of 89 mg KOH/g on resin solids.

TABLE 7
Polyurethane Dispersion PUD-5 Formulation

| Charge | Raw Material | Amount (g) |
|---|---|---|
| 1 | PU-2 | 200.0 |
| 2 | Diisopropylethyl amine | 22.3 |
| 3 | Deionized Water | 200.5 |

### Example 8: Preparation of Acid Functional Resin Dispersion

A polyurethane dispersion PUD-6 was prepared according to the formulation of Table 8. To a four necked reaction flask outfitted with a stirrer, gas inlet, thermometer and condenser was added the contents of Charge 1 and heated to 60° C. Charge 2 was added over 15 minutes followed by Charge 3. The polyurethane dispersion had a measured solid content of 38.4% and a measured acid value of 89 mg KOH/g on resin solids.

TABLE 8
Polyurethane Dispersion PUD-6 Formulation

| Charge | Raw Material | Amount (g) |
|---|---|---|
| 1 | PU-2 | 200.0 |
| 2 | Dimethylethanol Amine | 15.4 |
| | Deionized Water | 138.1 |
| 3 | Deionized Water | 68.3 |

### Example 9: Preparation of Acid Functional Resin Dispersion

A polyurethane dispersion PUD-7 was prepared according to the formulation of Table 9. To a four necked reaction flask outfitted with a stirrer, gas inlet, thermometer and condenser was added the contents of Charge 1 and heated to 60° C. Charge 2 was added followed by charge 3. The polyurethane dispersion had a measured solid content of 41.5% and a measured acid value of 86 mg KOH/g on resin solids.

TABLE 9
Polyurethane Dispersion PUD-7 Formulation

| Charge | Raw Material | Amount (g) |
|---|---|---|
| 1 | PU-2 | 200.0 |
| 2 | Methyldiethanol amine | 19.6 |
| 3 | Deionized Water | 180.43 |

### Example 10: Preparation of Acid Functional Resin Dispersion

A polyurethane dispersion PUD-8 was prepared according to the formulation of Table 10. To a four necked reaction flask outfitted with a stirrer, gas inlet, thermometer and condenser was added the contents of Charge 1 and heated to 60° C. Charge 2 was added followed by charge 3. The polyurethane dispersion had a measured solid content of 43.7% and a measured acid value of 81 mg KOH/g on resin solids.

TABLE 10
Polyurethane Dispersion PUD-8 Formulation

| Charge | Raw Material | Amount (g) |
|---|---|---|
| 1 | PU-2 | 200.0 |
| 2 | Triethanol Amine | 24.5 |
| 3 | Deionized Water | 180.43 |

### Example 11: Preparation of Acid Functional Resin Dispersion

A polyurethane dispersion PUD-9 was prepared according to the formulation of Table 11. To a four necked reaction flask outfitted with a stirrer, gas inlet, thermometer and condenser was added the contents of Charge 1. After the exotherm subsided, the temperature was raised to 75° C. and held for 5 hours. The NCO equivalent weight was measured (1312 g/eq, theory 1290 g/eq). The reaction was cooled to 65° C. Charge 2 was added followed by Charge 3. The reaction was held at 75° C. until the NCO was undetectable as measured by FTIR. An aqueous dispersion was produced by adding Charge 3 and Charge 4. The final dispersion had a measured solids content of 44.3% and a theoretical acid value of 101 mg KOH/g on resin solids.

TABLE 11
Polyurethane Dispersion PUD-9

| Charge | Raw Material | Amount (g) |
|---|---|---|
| 1 | PolyTHF ® 650¹ | 97.5 |
| | Dimethyol Propionic Acid | 40.2 |
| | Isophorone Diisocyanate | 133.2 |
| | Dibutyltin Dilaurate | 0.135 |
| | Methyl Ethyl Ketone | 116.1 |
| 2 | 3 Mercaptopropionic Acid | 31.3 |
| | Methyl Ethyl Ketone | 13.7 |
| 3 | Triethyl Amine | 0.61 |
| 4 | Triethyl Amine | 41.4 |
| 5 | Deionized Water | 281.6 |

¹Available from BASF

### Example 12: Preparation of Acid Functional Resin Dispersion

A polyurethane dispersion PUD-10 was prepared according to the formulation of Table 12. To a four necked reaction flask outfitted with a stirrer, gas inlet, thermometer and condenser was added the contents of Charge 1. After the exotherm subsided, the temperature was raised to 75° C. and held for 7.5 hours. The NCO equivalent weight was measured (2356 g/eq, theory 2255 g/eq). The reaction was cooled to 50° C. Charge 2 was added over 10 minutes. The reaction was held at 65° C. until the NCO was undetectable as measured by FTIR. An aqueous dispersion was produced by adding Charge 3 followed by Charge 4. The final dispersion had a measured solids content of 37.3% and a theoretical acid value of 33 mg KOH/g on resin solids.

TABLE 12
Polyurethane Dispersion PUD-10

| Charge | Raw Material | Amount (g) |
|---|---|---|
| 1 | PolyTHF ® 2000¹ | 160.0 |
| | Dimethyol Propionic Acid | 21.4 |
| | Isophorone Diisocyanate | 71.0 |
| | Dibutyltin Dilaurate | 0.13 |
| | Methyl Ethyl Ketone | 108.3 |
| 2 | Methyl ethanolamine | 10.7 |
| | Methyl Ethyl Ketone | 4.5 |
| 3 | Triethyl Amine | 12.3 |
| 4 | Deionized Water | 341.0 |

¹Available from BASF

### Example 13: Preparation of Acid Functional Resin Dispersion

A polyurethane dispersion PUD-11 was prepared according to the formulation of Table 13. To a four necked reaction flask outfitted with a stirrer, gas inlet, thermometer and condenser was added the contents of Charge 1. After the exotherm subsided, the temperature was raised to 80° C. and held for 6 hours. The NCO equivalent weight was measured (3723 g/eq, theory 3843 g/eq). The reaction was cooled to 50° C. Charge 2 was added. The reaction was held at 50° C. until the NCO was undetectable as measured by FTIR. Charge 3 was added. The temperature was raised to 75° C. and held until the anhydride was undetectable as measured by FTIR. An aqueous dispersion was produced by adding Charge 4 followed by Charge 5. The final dispersion had a measured solids content of 33.2% and a theoretical acid value of 38 mg KOH/g on resin solids.

TABLE 13
Polyurethane Dispersion PUD-11

| Charge | Raw Material | Amount (g) |
|---|---|---|
| 1 | PolyTHF ® 2000¹ | 200.1 |
| | Dimethyol Propionic Acid | 13.4 |
| | Isophorone Diisocyanate | 55.6 |
| | Dibutyltin Dilaurate | 0.13 |
| | Methyl Ethyl Ketone | 115.6 |
| 2 | Diethanol amine | 10.5 |
| | Methyl Ethyl Ketone | 4.5 |
| 3 | Succinic anhydride | 9.95 |
| | Methyl Ethyl Ketone | 4.5 |
| 4 | Triethylamine | 13.7 |
| 5 | Deionized Water | 386.7 |

¹Available from BASF

### Example 14: Preparation of Acid Functional Resin Predispersion

Acrylic-1 was prepared according to the formulation in Table 14.

To a four necked reaction flask outfitted with a stirrer, gas inlet, thermometer and condenser was added the contents of Charge 1 and heated to reflux. 96% of Charge 2 and all of Charge 3 were added dropwise over 3 hours letting the reaction reflux. Charge 4 was added. The reaction was held for 30 minutes. The remainder of Charge 2 was added over 30 minutes followed by Charge 5. After 30 minutes the reaction was cooled.

TABLE 14
Acrylic predispersion Acrylic-1

| Charge | Raw Material | Amount (g) |
|---|---|---|
| 1 | Methyl Isobutyl Ketone | 235.3 |
| 2 | Methyl Isobutyl Ketone | 196.1 |
| | Luperox 575² | 68.6 |
| 3 | Styrene | 245.1 |
| | Butyl Methacrylate | 245.1 |
| | Butyl Acrylate | 294.1 |
| | (Hydroxyethyl)methacrylate | 98.0 |
| | Acrylic Acid | 98.0 |
| 4 | Methyl Isobutyl Ketone | 9.8 |
| 5 | Methyl Isobutyl Ketone | 9.8 |

²t-Amyl peroctoate available from Arkema Global

### Example 15: Preparation of Acid Functional Resin Dispersion

Acrylic-2 was prepared according to the formulation in Table 15.

To a four necked reaction flask outfitted with a stirrer, gas inlet, thermometer and condenser was added the contents of Charge 1 and heated to 60° C. Charge 2 was added followed by Charge 3 dropwise. The final dispersion had a measured solids of 27.6 wt % and a measured acid value of 75.5 mg KOH/g on resin solids.

TABLE 15
Acrylic Dispersion Acrylic-2

| Charge | Raw Material | Amount (g) |
|---|---|---|
| 1 | Acrylic-1 | 250.0 |
| 2 | Triethyl amine | 16.2 |
| 3 | Deionized water | 384.3 |

### Example 16: Preparation of Acid Functional Resin Dispersion

Acrylic Dispersion-3 was prepared according to the formulation in Table 16. To a four necked reaction flask outfitted with a stirrer, gas inlet, thermometer and condenser was added the contents of Charge 1 and heated to 60° C. Charge 2 was added followed by Charge 3 dropwise. The final dispersion had a measured solids of 25.7 wt % and a measured acid value of 74.7 mg KOH/g on resin solids.

TABLE 16
Acrylic Dispersion Acrylic-3

| Charge | Raw Material | Amount (g) |
|---|---|---|
| 1 | Acrylic-1 | 250.0 |
| 2 | Dimethylethanol Amine | 14.1 |
| | Deionized water | 33.1 |
| 3 | Deionized water | 377.7 |

### Example 17: Preparation of Acid Functional Resin Dispersion

Polyester-1 was prepared according to the formulation in Table 17.

To a four necked reaction flask outfitted with a stirrer, gas inlet, thermometer and packed glycol recovery column was added the contents of Charge 1 and slowly heated to 175° C. Once an acid value of 54 mg KOH/g was achieved the reaction was cool to 135° C. Charge 2 was added to aid in cooling the reaction to 90° C. Charge 3 (under constant agitation) and Charge 4 were added alternatively (⅓ Charge 3, ½ Charge 4, ⅓ Charge 3, ½ Charge 4, ⅓ Charge 3) in order to attain a dispersion with a measured solids of 37.9 wt % and a measured acid value of 55.7 mg KOH/g on resin solids.

TABLE 17
Polyester Dispersion Polyester-1

| Charge | Raw Material | Amount (g) |
|---|---|---|
| 1 | PolyTHF ® 650¹ | 650.0 |
| | 1,6-Hexanediol | 177.0 |
| | Trimellitic Anhydride | 288.0 |
| | Triphenyl Phosphite | 1.1 |
| 2 | Dowanol PM³ | 53.7 |
| 3 | Triethylamine | 75.8 |
| | Deionized Water | 681.8 |
| 4 | Deionized Water | 949.9 |

¹Available from BASF
³Glycol ether available from Dow Chemical

### Example 18: Preparation of Acid Functional Resin Dispersion

Polyester-2 was prepared according to the formulation in Table 18.

To a four necked reaction flask outfitted with a stirrer, gas inlet, thermometer and packed glycol recovery column was added the contents of Charge 1 and slowly heated to 175° C. Once an acid value of 54 mg KOH/g was achieved the reaction was cool to 135° C. Charge 2 was added to aid in cooling the reaction to 90° C. Charge 3 and Charge 4 were added alternatively (⅓ Charge 3, ½ Charge 4, ⅓ Charge 3, ½ Charge 4, ⅓ Charge 3) in order to attain a dispersion with a measured solids of 37.8 wt % and a measured acid value of 57.1 mg KOH/g on resin solids.

TABLE 18
Polyester Dispersion Polyester-2

| Charge | Raw Material | Amount (g) |
|---|---|---|
| 1 | PolyTHF ® 650¹ | 650.0 |
| | 1,6-Hexanediol | 177.0 |
| | Trimellitic Anhydride | 288.0 |
| | Triphenyl Phosphite | 1.1 |
| 2 | Dowanol ™ PM³ | 53.7 |
| 3 | Dimethylethanol Amine | 66.8 |
| | Deionized Water | 600.8 |
| 4 | Deionized Water | 1031.9 |

¹Available from BASF
³Available from Dow Chemicals

### Example 19: Formation of a Branched Carbodiimide

A carbodiimide, CDI-1, was prepared according to the formulation of Table 19.o a four necked reaction flask outfitted with a stirrer, gas inlet, thermometer and condenser was added the contents of Charge 1 and heated to 160° C. The reaction was held until the measured isocyanate value was greater than 384 g/eq. The reaction was cooled to room temperature which was facilitated by adding Charge 2. The resulting NCO prepolymer had a measured isocyanate value of 532 g/eq and 66.3 wt % solids. A portion of the NCO prepolymer and Charge 3 were heated to 70° C. and held for 1 hour. Charge 4 followed by Charge 5 were added and the reaction was held at 80° C. until the NCO was not present via FTIR analysis. The reaction was dispersed by adding Charge 6. The dispersed materials had a solids content of 34.2 wt % and a theory carbodiimide equivalent weight of 646 g/eq on resin solids.

TABLE 19
Branched Carbodiimide CDI-1

| Charge | Raw Material | Amount (g) |
|---|---|---|
| 1 | Desmodur W⁴ | 944.7 |
| | Phospholene Oxide | 2.5 |
| | Butyl Acetate | 94.4 |
| 2 | Butyl Actetate | 311.4 |
| 1 + 2 | NCO prepolymer | 319.2 |
| 3 | Dibutyltin Dilaurate | 0.036 |
| | MPEG 550⁵ | 165.0 |
| | Butyl Acetate | 8.5 |
| 4 | TMP-EO⁶ | 17.4 |
| 5 | Butyl Acetate | 1.7 |
| 6 | Deionized Water | 656 |

⁴Cycloaliphatic diisocyanate available from Covestro AG
⁵CARBOWAX Methoxypolyethylene Glycol 550 available from Dow Chemical
⁶Trimethylolpropane ethoxylate available from Sigma Aldrich average Mₙ ~170

### Example 20: Preparation of Acid Cure Curable Compositions

The coating formulations A-O of the present disclosure were prepared in the amounts shown in Table 20 using the following method. Curable compositions 1 and 2, not made according to this disclosure and marked “comparative”, were prepared in the amounts shown in Table 20 using the following method. All values in Table 20 are given in parts by weight in grams.

The polyurethane dispersion, water, and silicone surfactant were mixed in a glass jar before Carbodilite V-02-L2 (available from Nisshinbo Chemical) was added and thoroughly stirred. The formulas were applied using an 8 mil gap square drawdown bar on to 4″×12″ steel substrate which was precoated with an ED7100 electrocoat primer (available from ACT Test Panels LLC (Hillsdale, MI)) which had been processed and baked according to the manufacture's recommendations. The films were flashed at ambient conditions for 15 minutes before being baked in a 60° C. oven for 40 minutes. Each coated panel was allowed to sit for 7 days at ambient conditions before being subjected to solvent resistance testing.

TABLE 20
Acid Cure Curable Composition Formulations Examples (Ex.)

| | Ex. | Ex. | Ex. | Ex. | Ex. | Ex. | Ex | Ex. | Ex. | Ex. | Ex. | Ex. | Ex. | Ex. | Ex. |
|---|---|---|---|---|---|---|---|---|---|---|---|---|---|---|---|
| | A | B | C* | D | E | F* | G* | H* | I | J* | K | L* | M | N* | O* |
| PUD-1 | 133.6 | | | | | | | | | | | | | | |
| PUD-2 | | 135.1 | | | | | | | | | | | | | |
| PUD-3 | | | 134.4 | | | | | | | | | | | | |
| PUD-4 | | | | 171.4 | | | | | | | | | | | |
| PUD-5 | | | | | 171.4 | | | | | | | | | | |
| PUD-6 | | | | | | 171.4 | | | | | | | | | |
| PUD-7 | | | | | | | 5.0 | | | | | | | | |
| PUD-8 | | | | | | | | 5.0 | | | | | | | |
| Acrylic-2 | | | | | | | | | 10.0 | | | | | | |
| Acrylic-3 | | | | | | | | | | 10.0 | | | | | |
| Polyester-1 | | | | | | | | | | | 10.0 | | | | |
| Polyester-2 | | | | | | | | | | | | 10.0 | | | |
| PUD-9 | | | | | | | | | | | | | 5.0 | | |
| PUD-10 | | | | | | | | | | | | | | 10.0 | |
| PUD-11 | | | | | | | | | | | | | | | 10.0 |
| Silicone | 0.8 | 0.8 | 0.8 | 0.8 | 0.8 | 0.8 | 0.05 | 0.05 | 0.1 | 0.1 | 0.1 | 0.1 | 0.1 | 0.1 | 0.1 |
| surfactant? | | | | | | | | | | | | | | | |
| Carbodimide⁸ | 111.1 | 111.1 | 111.1 | 111.1 | 111.1 | 111.1 | 3.1 | 3.0 | 3.6 | 3.3 | 3.5 | 3.6 | | 2.2 | 2.2 |
| CDI-1 | | | | | | | | | | | | | 7.5 | | |
| Deionized | 65.5 | 65.5 | 65.5 | 29.3 | 29.3 | 29.3 | 2.0 | 2.4 | 5.6 | 5.5 | 5.6 | 5.6 | 3.7 | 3.3 | 5.1 |
| Water | | | | | | | | | | | | | | | |

⁷BYK-348 available from BYK.
⁸Carbodilite V-02-L2 available from Nisshinbo Chemical.
*Comparative

TABLE 21
Acid Cure Curable Composition Formulations Results

| | Ex. | Ex. | Ex. | Ex. | Ex. | Ex. | Ex. | Ex | Ex. | Ex. | Ex. | Ex. | Ex. | Ex. | Ex. |
|---|---|---|---|---|---|---|---|---|---|---|---|---|---|---|---|
| | A | B | C* | D | E | F* | G* | H* | I | J* | K | L* | M | N* | O* |
| 7 Day MEK | 150 | 120 | 40 | 163 | 119 | 38 | 20 | 100^{a} | 100^{a} | 100^{a} | 100^{a} | 100^{a} | 100^{a} | 100^{a} | 100^{a} |
| Double Rubs | | | | | | | | | | | | | | | |
| MEK Rating | ND | ND | ND | ND | ND | ND | 2 | 2 | 5 | 5 | 9 | 9 | 9 | 2 | 8 |
| Crosslink | ND | ND | ND | 0.951 | 1.153 | 0.550 | 0.03 | 0.02 | 1.660 | 0.991 | 0.792 | 0.492 | ND | 0.421 | 0.456 |
| Density | | | | | | | | | | | | | | | |
| (mmol/cm³) | | | | | | | | | | | | | | | |

^{a}7 day MEK Double Rubs stopped at a maximum of 100 and MEK rating was assigned
ND-not determined

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An aqueous curable composition comprising:
a resin comprising acid functional groups, the resin having an acid value from 50 mg KOH/g to 150 mg KOH/g, on resin solids according to ASTM D 4662-15;
a tertiary alkylated amine; and
a multifunctional carbodiimide.

2. The curable composition of claim 1, wherein the composition comprises less than 5 wt. % of an amine that comprises one or more hydroxyl groups, based on a solids of the composition.

3. The curable composition of claim 1, wherein the composition comprises less than 10 wt. % of the tertiary alkylated amine, based on a total weight of the composition.

4. The curable composition of any preceding claim, wherein the curable composition is substantially free of amines that comprise a hydroxyl group.

5. The curable composition of claim 1, wherein the resin comprising acid functional groups comprises a polyester, a polyurethane and/or an acrylic resin.

6. The curable composition of claim 1, wherein the carbodiimide comprises a linear or branched multifunctional carbodiimide.

7. The curable composition of claim 1, further comprising a solvent.

8. The curable composition of claim 1, wherein the composition is curable t a temperature of from 0° C. to 120° C.

9. The curable composition of claim 1, wherein a stoichiometric ratio of carbodiimide to acid is from 1:2 to 2:1.

10. The curable composition according to claim 1, wherein the resin comprising acid functional groups has a number average molecular weight, of from 500 g/mol to 50,000 g/mol determined by gel permeation chromatography using polystyrene standards.

11. An article comprising the curable composition of claim 1 deposited over at least a part of a surface of the article and cured to form a cured layer.

12. The article of claim 11, wherein the curable composition is cured at a temperature of from 0° C. to 120° C.

13. A method of applying the curable composition according to claim 1, comprising:
applying the curable composition over at least a portion of a surface of an article or substrate using spray coating, roller coating, coil coating, dip coating, precision coating, and/or spin coating techniques; and
curing the curable composition to form a cured layer.

14. The method of claim 13, wherein the curable composition is cured at a temperature of from 0° C. to 120° C.
